(19) United States
(12) Patent Application Publication
(10) Pub. No.: US 2004/0222315 A1
(43) Pub. Date: Nov. 11, 2004

(54) Device for spraying a substance, including a removable reservoir

(75) Inventor: Jacques Habatjou, Cambrai (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 10/830,121

(22) Filed: Apr. 23, 2004

Related U.S. Application Data
(60) Provisional application No. 60/470,494, filed on May 15, 2003.
(60) Provisional application No. 60/470,495, filed on May 15, 2003.

(30) Foreign Application Priority Data
Apr. 24, 2003 (FR) 03 05034
Apr. 24, 2003 (FR) 03 05035

(51) Int. Cl. B05B 7/32

(52) U.S. Cl. 239/308; 239/303; 239/337

(57) ABSTRACT

A spray device includes a spray mechanism and a reservoir containing a substance for spraying. For example, the substance may be a cosmetic or other care product. The reservoir is arranged so as to be capable of being removably mounted on the device so that the substance can be selectively dispensed by the spray mechanism. The reservoir includes a substance outlet passage and a closure member for closing the passage when the reservoir is not mounted on the device. The spray mechanism and the closure member are arranged so that the closure member opens in response to the reservoir being mounted on the device. The reservoir also includes at least a first partition and first and second compartments capable of containing the substance. The compartments are arranged to feed the spray mechanism with the substance and are disposed on either side of the first partition.

### CROSS-REFERENCE TO RELATED APPLICATIONS

This application claims the benefit of French Applications Nos. 03 05034 and 03 05035 filed on Apr. 24, 2003 and U.S. Provisional Applications Nos. 60/470,494 and 60/470,495 filed on May 15, 2003, the entire disclosures of which are incorporated by reference herein.

### FIELD OF INVENTION

The present invention relates to devices for spraying a substance, such as a cosmetic or other care product.

### BACKGROUND

It is known to apply makeup to the skin by use of an air brush comprising a spray stylus connected to a bottle of compressed vector gas. The spray stylus comprises firstly a nozzle for ejecting the vector gas and secondly a cup in which the substance for spraying is contained. The substance is progressively sucked out from the cup by suction that is established at an outlet orifice of a duct connected to the cup. The suction is created by the Venturi effect by the speed of the vector gas flowing past the outlet orifice on leaving the nozzle. The substance may also be entrained out from the cup via the duct when the outlet orifice is located upstream relative to the outlet from the nozzle.

Spraying with an air brush makes it possible in particular to ensure that the boundary between zones of skin that have been treated and zones that have not been treated is less visible, and to produce shading or blending effects.

The operations to be performed while applying makeup are also different when spraying with an air brush, since the sprayed substance does not need to be spread once it has been deposited. Application of the substance is thus very hygienic since it can be performed without using fingers or an applicator.

A drawback of prior art devices is that it is relatively difficult to deposit exactly the desired quantity of substance.

U.S. Pat. Nos. 3,675,824 and 4,714,084 and French patent document Nos. FR-A-1,280,048, FR-A-1,499,794 and FR-A-2,781,208 disclose various spray devices that make use of a vector gas.

In patent document No. FR-A-1,449,794, the substance is contained in a relatively large can which is used as a handle member. Such a device is not very ergonomic and does not facilitate use of a removable reservoir of small capacity.

### SUMMARY OF THE INVENTION

Exemplary embodiments of the invention provide improved spray devices that make it easier to obtain neatly-applied makeup.

Exemplary embodiments of the invention provide a spray device that is relatively compact and ergonomic, that enables makeup to be applied neatly, and/or that allows, where appropriate, use of successive substances of different tints.

In embodiments, the invention provides a spray device comprising: a spray mechanism; and a reservoir containing a substance for spraying, arranged in such a manner as to be capable of being removably fastened on the device so that the substance can be selectively dispensed by the spray mechanism, the reservoir including: a substance outlet passage; and a closure member for closing the passage when the reservoir is not mounted on the device, the mechanism and the closure member being arranged in such a manner that the closure member opens in response to the reservoir being mounted on the device.

Exemplary embodiments of the invention make it possible for a user to easily apply a plurality of makeup substances of different colors using the same spray mechanism, for example, by interchanging a plurality of reservoirs containing the different colored substances, as desired. The risk of substance leakage is limited by the fact that as soon as a reservoir is removed, the substance outlet passage closes automatically.

In exemplary embodiments of the invention, the reservoir may include at least a first partition and first and second compartments capable of containing the substance, the compartments being arranged to feed the spray mechanism with substance and being disposed on either side of the first partition.

In such embodiments, it is thus possible, for example, to fasten the reservoir on a top portion of the spray device while ensuring continuity of substance feed when applying makeup, even in the event of changing the inclination of the reservoir, since the first partition slows down movements of substance in the reservoir. Thus such embodiments provide a device that is suitable for being used in a large number of positions as may be encountered, for example, when making up the face.

The term “partition” should not be understood in a limited sense, and should be understood to cover, for example, walls that are solid, hollow, perforated, rigid, flexible, porous, plane, cylindrical, or that have other shapes. For example, the term partition should be understood to cover walls suitable for being formed by juxtaposing obstacles to the flow of the substance.

In exemplary embodiments, the reservoir and the device may be arranged so as to enable the reservoir to be fixed on the device close to the outlet orifice for the substance to be sprayed. Such embodiments thus make it possible, where desirable, to convey the substance more quickly to the outlet orifice and/or to reduce the volume of substance that remains inside the device, outside the reservoir, between two uses.

In exemplary embodiments, the passage through which the substance flows out from the reservoir may lead, for example, at one end to either side of the first partition, the first and second compartments both communicating via the passage.

In exemplary embodiments, the closure member may comprise a ball check valve. In such embodiments, the spray mechanism may then include a portion in relief arranged to move the ball away from a position that closes the passage to a position that opens the passage when the reservoir is put into place.

In exemplary embodiments, the reservoir may include at least one second partition on one side of the first partition, associated with the first compartment and defining therein two sub-compartments that are in communication with each other. In such embodiments, the reservoir may also include at least one third partition associated with the second compartment and defining therein two sub-compartments, the first partition being situated between the second and third partitions.

In exemplary embodiments, the reservoir may include a base portion and a lid-forming portion fitted on the base portion. The second and third partitions may then be made integrally with at least one of the base portion and the lid-forming portion.

In exemplary embodiments, the reservoir may be of generally elongate shape, having a longitudinal axis substantially parallel to the direction in which spraying is to take place.

In exemplary embodiments, the passage of the reservoir through which the substance is delivered to the mechanism may be defined at least in part by an endpiece. The endpiece may be projecting. The endpiece may carry a sealing O-ring.

In exemplary embodiments, the reservoir may be at least partially transparent, for example, in order to enable a user to observe the level and/or the color of the substance.

In exemplary embodiments, the reservoir may further include a fastener portion arranged to co-operate by complementary shapes with the spray mechanism.

In exemplary embodiments, the reservoir may also include a micro-orifice opening out to ambient air.

In exemplary embodiments, the spray mechanism may include a housing for receiving a supply of vector gas, whereby the substance may be sprayed by suction created by a stream of the vector gas. The gas may be stored in liquid form in a pressurized receptacle. A moving cap may enable access to the housing to be closed.

In exemplary embodiments, the spray mechanism may include a control member arranged to act simultaneously both on a valve for dispensing the vector gas and on a valve for adjusting the flow rate of the sprayed substance.

In exemplary embodiments, the adjustment valve includes a plunger arranged to co-operate with an associated seat so that the flow rate of the sprayed substance varies with varying spacing between the seat and the plunger. Such an adjustment valve enables the user to adjust the quantity of substance that is sprayed both progressively and accurately.

In exemplary embodiments, the control member may comprise a pivoting lever.

In exemplary embodiments, the dispenser valve may be secured to the pressurized receptacle, thus making it possible to benefit from an economy of scale in the provision thereof, and, for example, to make use of a conventional dispenser valve that is triggered by titling a control rod.

In exemplary embodiments, the seat may be situated on a support part for at least one substance spray nozzle. The support part may be made of plastics material and may be releasably fastened on the device.

In exemplary embodiments, the device includes two vector gas outlet nozzles and one outlet nozzle for the substance to be sprayed. Each nozzle may be made of metal. For example, the device may include two vector gas outlet orifices having axes that converge in a direction going away from the device, and the substance outlet orifice may have an axis that lies substantially in a same plane as the axes of the vector gas outlet orifices. Such an arrangement makes it possible, for example, to obtain a spray that is relatively gentle, providing good conditions for application.

In other exemplary embodiments, the plunger slides in a direction substantially parallel to a direction in which the substance is sprayed. The device may include a spring for returning the plunger into a rest position in which the plunger presses against the seat. Where appropriate, the control member does not have a return spring specific thereto.

In exemplary embodiments, the device may include an endpiece arranged to be engaged on a control rod of the dispenser valve. In such embodiments, the control member may be arranged to be capable of pressing against the endpiece.

In exemplary embodiments, a mirror may be hinged to the spray mechanism so as to enable the user to observe the zone onto which the substance is being sprayed.

In exemplary embodiments, the spray mechanism may be general elongate in shape and the control member may have a presser face for the user, located on a longitudinal side of the device. In embodiments, the device may equally well be in the general form of a pistol.

For example, the control member may have a presser face for the user disposed on one side of a pistol grip, the one side being situated opposite from an orifice through which the sprayed substance exits. The grip may house the pressurized receptacle.

In exemplary embodiments, the reservoir of substance and the pressurized receptacle may be linked together in fixed manner so that neither can move relative to the other in use.

The substance which is sprayed may be a liquid or a powder, and may be a cosmetic, such as a foundation, or other care product

Exemplary embodiments of the invention further provide, either independently or in combination with the foregoing features, a spray device comprising: a spray mechanism; and a reservoir containing a substance to be sprayed, the reservoir including at least a first partition and first and second compartments capable of containing the substance, the compartments being arranged to feed the spray mechanism with substance and being disposed on either side of the first partition.

Exemplary embodiments of the invention also provide, either independently or in combination with the foregoing features, a mechanism for spraying at least one substance contained in a reservoir, such as a cosmetic or other care product, the substance being taken from the reservoir by suction created at a reservoir outlet orifice by a stream of a vector gas, the vector gas being stored in a pressurized receptacle, the device including a valve for adjusting the flow rate of the sprayed substance and a control member capable of being operated by a user to act simultaneously on a vector gas dispenser valve and on an adjustment valve, the adjustment valve including a plunger arranged to co-operate with an associated seat in such a manner that the flow rate of the sprayed substance varies with varying spacing between the seat and the plunger.

According to exemplary embodiments of the invention, the flow rate of the substance can be adjusted progressively and accurately by the user, thereby making it easier to obtain high quality makeup.

In exemplary embodiments of the invention, the control member may comprise a pivoting lever. Such a lever can be made, where appropriate, to be relatively long, so as to enable the lever to be actuated by the user without requiring the user to exert a large force.

In exemplary embodiments, the dispenser valve may be preferably secured to the pressurized receptacle. This can enable the cost of the device to be reduced by taking advantage of an economy of scale by using a conventional dispenser valve, for example, a valve that is triggered by tilting a control rod.

In exemplary embodiments, the seat may be situated on a part for supporting at least one substance spray nozzle. The support part may be made of plastics material, and where appropriate, the support part may be releasably fastened to the device, thus making it easier to clean or enabling the nozzle(s) to be changed as a function of the shape desired for the spray.

In other exemplary embodiments, the device may include two vector gas outlet nozzles and one outlet nozzle for the substance to be sprayed. For example, the device may include two vector gas outlet orifices having axes that converge in a direction going away from the device. This enables a more gentle spray to be obtained. The substance outlet orifice may have an axis that is situated substantially in a same plane as the axes of the vector gas outlet orifices.

Each nozzle may be made of metal, and, for example, may be made by turning. This enables high quality nozzles to be obtained at low cost, for example, without requiring an investment in making molds.

In exemplary embodiments, the device may be advantageously portable and cordless, and may include a housing for receiving the pressurized receptacle. The device may include a moving cap, for example, a hinged cap, that enables access to the housing to be closed.

In exemplary embodiments, the plunger may slide in a direction substantially parallel to the direction in which the substance is sprayed. The device may include a spring that returns the plunger toward a rest position in which the plunger presses against the seat. The control member thus need not have a return spring of its own.

In exemplary embodiments, the device may include an endpiece arranged to engage on a control rod of the dispenser valve, and the control member may be arranged to be capable of pressing against the endpiece when the control member is operated to trigger spraying.

In exemplary embodiments of the invention, the device may include a hinged mirror.

In exemplary embodiments, the control member may be positioned in various ways on the device.

In exemplary embodiments, the device may have a generally elongate shape and the control member may have a presser face for the user disposed on a longitudinal side of the device. Such a disposition can be particularly ergonomic.

In exemplary embodiments, the device may also be generally pistol shaped. In such embodiments, the control member may then have a presser face for the user disposed on one side of a pistol grip, the one side being, for example, situated opposite from an orifice through which the sprayed substance exits. The grip may house the pressurized receptacle.

In exemplary embodiments of the invention, the reservoir of substance and the pressurized receptacle are secured together with neither of them being movable relative to the other in use. The reservoir may include a micro-orifice opening out to the ambient atmosphere or may include an air intake valve. The reservoir may be releasably fastened to the device.

Exemplary embodiments of the invention provide a kit comprising a device, as described above, together with a reservoir containing the substance to be sprayed.

### BRIEF DESCRIPTION OF THE DRAWINGS

The present invention will be better understood on reading the following detailed description of non-limiting embodiments thereof, and on examining the accompanying drawings, in which:

FIG. 1 is a diagrammatic side view of a spray device according to an embodiment of the invention;

FIG. 2 is partially cut-away side view of the device of FIG. 1 illustrating details of the structure of the spray mechanism of the exemplary embodiment;

FIG. 3 is a partial diagrammatic axial cross-section view of an exemplary spray head suitable for fitting to the spray device of the exemplary embodiment;

FIG. 4 is a partially cross-sectioned side view of a spray device according to another exemplary embodiment of the invention;

FIG. 5 is a longitudinal cross-section view of an exemplary embodiment of the reservoir;

FIG. 6 is a cross-section view taken along VI-VI of FIG. 5;

FIG. 7 is a fragmentary cross-section view taken along VII-VII of FIG. 5 illustrating the endpiece of the reservoir;

FIG. 8 is a diagrammatic cross-section view taken along VIII-VIII of FIG. 6 illustrating the reservoir being put into place on the spray device; and

FIG. 9 is a diagrammatic cross-section view analogous to FIG. 8 illustrating the reservoir having been put into place.

### DETAILED DESCRIPTION OF EXEMPLARY EMBODIMENTS

The term “care products” is used to generically refer to any substance that is used to effect one or more external body conditions, such as conditions of the skin, hair and nails. For example, such substances include, but are not limited to, treatment products, such as sunscreen, moisturizer and/or medicaments, cleansing products and cosmetic products, such as makeup products, or any other known or later developed product that ma be applied to the body.

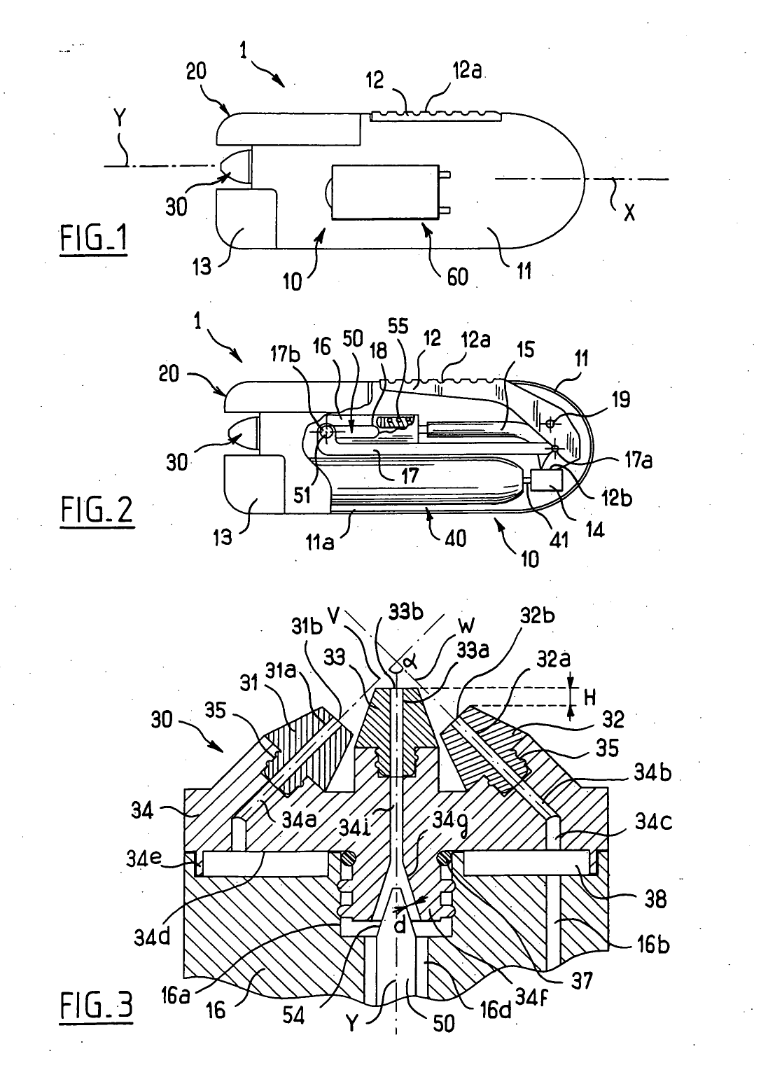

The spray device 1 shown in FIGS. 1 and 2 comprises a spray mechanism 10 and a removable reservoir 20 containing a substance to be sprayed, for example, a liquid foundation.

The spray mechanism 10 comprises a casing 11, for example, made by assembling together two shells of plastics material, and a moving control member 12 that enables spraying to be triggered.

In the exemplary embodiment shown, the casing 11 is generally elongate in shape along a longitudinal axis X that is substantially parallel to a direction along an axis Y in which the substance is sprayed by a spray head 30.

The control member 12 has a top face 12a on which a user can press in order to cause dispensing to take place. In the exemplary embodiment shown, the top face 12a extends over a top longitudinal side of the mechanism 10. The lever 12 is hinged on a pivot 19 which is stationary relative to the casing 11. For example, the axis about which the control member 12 pivots is orthogonal to the longitudinal axis X, and may intersect the axis X. In the exemplary embodiment shown, the control member 12 has two aims, the first arm defining the top face 12a, and the second arm defining an end 12b whose function is described below.

The casing 11 includes a housing 11a which receives a pressurized receptacle 40 containing a vector gas, for example, butane, isobutane, or isopropane, or a liquefied fluorine compound. The receptacle 40 is fitted with a dispenser valve having a hollow control rod 41, the rod 41 actuating the dispenser valve when the rod 41 is tilted.

The receptacle 40 may be inserted inside the casing 11 via a removable cap 13. The control rod 41 engages in an endpiece 14 which co-operates with the control member 12, for example, with the end 12b.

The endpiece 14 also opens out into a tube 15 into which gas contained in the pressurized receptacle 40 escapes when the control rod 41 is tilted under drive from the control member 12.

The tube 15 opens into a guide assembly 16 in which a plunger 50 can slide parallel to the axis Y, which is parallel or coincides with the longitudinal axis X.

The plunger 50 may be moved by a rod 17 connected at one end 17a to the lever 12 and at its other end 17b to a stud 51 secured to the plunger 50. The stud 51 slides in a slot 18 of the guide assembly 16. In the exemplary embodiment shown, the spray head 30 has two vector gas spray nozzles 31 and 32 and a single nozzle 33 for spraying substance contained in the reservoir 20. The nozzles 31 to 33 may be fixed to a common support piece 34 that is fixed to the guide assembly 16.

In the exemplary embodiment shown, the nozzles 31 and 33 are made by turning a metal, and each has a threaded portion 35, that enables the respective nozzle to be assembled to the support piece 34, and a respective internal channel 31a, 32a, or 33a.

Respective axes V and W of outlet orifices 31b and 32b of the nozzles 31 and 32 intersect in front of the nozzle 33 and form therebetween an angle α, for example, that is close to 90° in the exemplary embodiment. A distance H measured between a front face of the nozzle 33 and the nozzles 31 and 32 is about 1.7 millimeters in the exemplary embodiment. For example, the diameter of the vector gas outlet orifices 31b and 32b is 0.4 mm, and the diameter of the substance outlet orifice 33b is 0.9 mm.

The support piece 34 includes two channels 34a and 34b communicating respectively with the channels 31a and 32a of the nozzles 31 and 32 at one end thereof and communicating at the other end thereof with an annular groove 34c that opens into a rear face 34d of the support piece 34. The support piece 34 has a sealing lip 34e which presses against a surface of the guide assembly 16 and has a threaded portion 34f which engages in a housing 16a of the guide assembly 16. The threaded portion 34f carries a sealing O-ring 37 which presses in a leaktight manner against the wall of the housing 16a. An annular chamber 38 is formed between the support piece 34 and the guide assembly 16, and the vector gas is conveyed into the annular chamber 38 by a channel 16b in the assembly 16. The channel 16b communicates with the tube 15.

The support piece 34 defines a seat 34g of conical shape against which the end 54 of the plunger 50, having the same conical shape, comes to bear when at rest. A channel 34i along the axis Y is formed in the support piece 34 and enables the substance to be sprayed to reach an internal channel 33a of the nozzle 33 when the end 54 of the plunger 50 is spaced apart from the seat 34g.

The plunger 50 is urged against the seat 34g by a helical spring 55 working in compression and housed in the guide assembly 16. The spring 55 is partially shown in FIG. 2, having one end pressing against a wall of the assembly 16 and an opposite end pressing against a shoulder on the plunger 50.

The device 1 operates as follows. When the user presses the face 12a of the lever 12, the lever 12 presses the end 12b against the endpiece 14, thereby tilting the control rod 41 to cause vector gas to be emitted. The vector gas travels, for example, through the endpiece 14, the tube 15, the channel 16b, and the channels 34a and 34b prior to leaving through the outlet orifices 31b and 32b of the nozzles 31 and 32.

The lever 12 also moves the rod 17 and the plunger 50 whose end 54 is spaced apart from the seat 34g by a distance d which is proportional to the angle through which the lever 12 is pivoted. By pressing on the lever 12 to a greater or lesser extent, the user can thus adjust the flow rate of the substance which is sucked out from the reservoir 20. The displacement of the lever 12 has an effect on the flow rate of the gas released by the pressurized receptacle 40, and thus on the magnitude of the suction created by the stream of vector gas past the outlet orifice 33b of the nozzle 33, thereby enabling more or less substance to be dispensed over the surface that is being treated.

The device 1 may be provided with a hinged mirror 60 having a reflecting surface that faces the casing 11 when the mirror is in a folded-down position, as shown in FIG. 1. In use, the user can cause the mirror 60 to turn through one-fourth of a turn and make use of the mirror to observe the makeup as the makeup is being applied by the spray device 1.

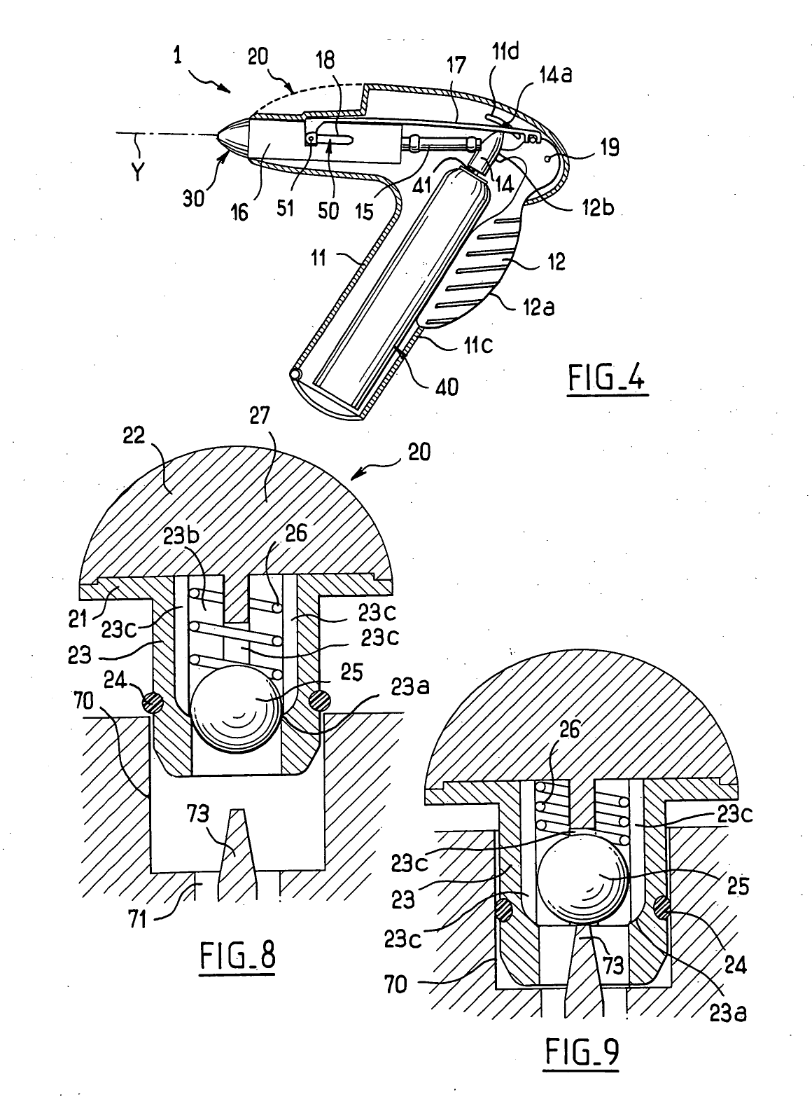

The device 1 may be implemented in forms other than that shown in FIGS. 1 and 2. For example, the spray device may have the general form of a pistol, as shown in FIG. 4.

In FIG. 4, the same reference numerals are used to designate elements that are identical or similar to those described above. As shown, the pressurized receptacle 40 can be received in the grip of the pistol, the face 12a of the lever 12 on which the user presses being situated on the side 11c of the grip which is opposite from the orifice through which the substance is dispensed.

The longitudinal axis of the receptacle 40 is an angle of about 60° relative to the axis Y.

When not spraying, the control rod 41 is oriented obliquely and toward the right, as shown in FIG. 4, where spraying is to take place toward the left.

As in the first exemplary embodiment described above, when the user presses on the lever 12, pivoting of the lever 12 causes the end 12b to press against the endpiece 14 so as to cause the endpiece 14 to tilt to the left. Consequently, this also causes the control rod 41 engaged in the endpiece 14 to tilt. Pivoting of the lever 12 is also accompanied by displacement of the rod 17 which moves the plunger 50 to the right, away from the seat 34g.

In the exemplary embodiment shown in FIG. 4, the tilting of the endpiece 14 is guided by studs 14a engaged in grooves 11d in the casing 11.

It may be advantageous for the reservoir 20 to be releasably fastened to the spray mechanism 10 so as to enable the user to replace the reservoir 20 with another reservoir once the substance contained therein has been used up.

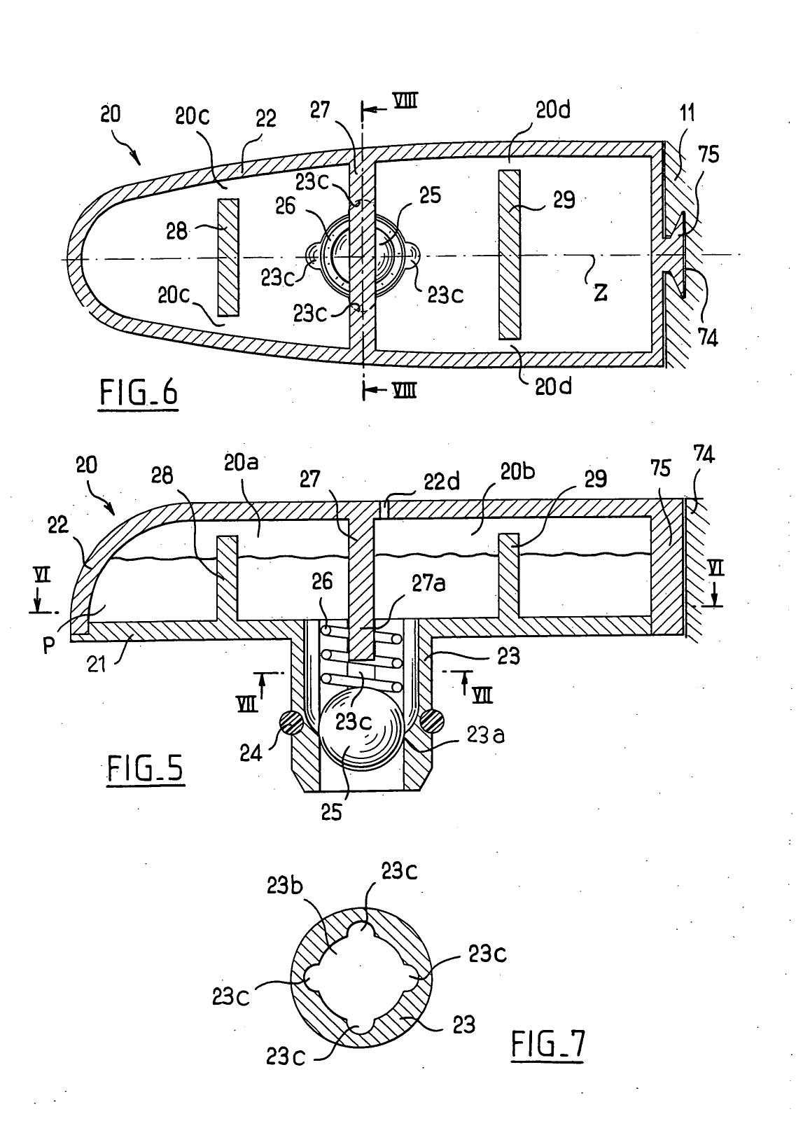

A description of an exemplary embodiment of the reservoir is provided with reference to FIGS. 5 to 9.

As shown in FIG. 5, for example, the reservoir 20 may comprise a base portion 21 and a lid 22 fitted on the base portion 21, the two portions being secured to each other, for example, by adhesive, heat-sealing, or snap-fastening.

The lid 22 is preferably made of a transparent material so as to enable the user to assess the amount and/or the color of a substance P contained inside the reservoir. The lid 22 may be pierced by a micro-orifice 22d for ingress of air. The micro-orifice 22d may be sufficiently small to prevent the substance P from flowing out through the micro-orifice 22d.

In the exemplary embodiment shown, the base portion 21 is made with a projecting endpiece 23 for engaging in a corresponding housing 70 on the spray mechanism 10. The housing 70 communicates via a duct 71 with the space 16d in which the plunger 50 slides.

The endpiece 23 carries an O-ring 24 that serves to prevent substance from leaking out once the endpiece 23 is in place in the housing 70, as shown in FIG. 9.

The endpiece 23 houses a check valve comprising a ball 25 and a spring 26 suitable for holding the ball 25 pressed against a corresponding seat 23a in the endpiece 23, as shown in FIG. 5, after the reservoir 20 has been closed and prior to the reservoir 20 being mounted on the spray mechanism 10.

The ball 25 is free to move in a passage 23b inside the endpiece 23. The passage 23b includes in a periphery thereof four longitudinal channels 23c that enable the substance contained in the reservoir 20 to go past the ball 25 and flow toward the housing 70 once the ball 25 has been lifted off the seat 23a. The ball 25 can be caused to move by a portion in relief 73 of the spray mechanism 10, as shown in FIG. 9. When the reservoir 20 is separated from the spray mechanism 10, the ball 25 comes again to bear against the seat 23a, thereby sealing off the passage 23b.

The reservoir 20 is generally elongate in shape along a longitudinal axis Z which, in the embodiment shown in FIGS. 1 and 2, is substantially parallel to the longitudinal axis X and to the spray direction Y. In the embodiment shown in FIG. 4, the axis Z is substantially parallel to the spray axis Y and is at an angle of about 45° with the longitudinal axis of the pistol grip.

While the user is handling the spray device 1 to apply makeup, the angle of inclination of the reservoir 20 is liable to vary. In accordance with embodiments of the invention, the reservoir 20 is made in such a manner that the passage 23b is always fed with substance.

In the embodiment shown in FIGS. 5 to 9, the reservoir 20 is thus made to have means for braking displacement of the substance within the reservoir 20. For example, the reservoir 20 may include a plurality of partitions, including a first partition 27 which defines first and second compartments 20a and 20b inside the reservoir 20 for containing the substance P.

Each of the first and second compartments 20a and 20b is itself subdivided into two sub-compartments by respective second and third partitions 28 and 29. In the exemplary embodiment shown, the second and third partitions 28 and 29 are integrally molded out of the same plastics material as the base portion 21, while the first partition 27 is integrally molded out of the same material as the lid 22.

The first partition 27 extends transversely, as shown in FIG. 6, across the entire width of the reservoir, while the second and third partitions 28 and 29 co-operate with the lid 22 to leave respective passages 20c and 20d that enable the substance to flow past the partitions inside the first and second compartments 20a and 20b whenever there is a change in the angle of inclination of the reservoir 20 about a horizontal axis perpendicular to the axis Z.

The partitions 28 and 29 thus brake the flow of the substance P, but without preventing the substance P from reaching the passage 23b.

Inside the endpiece 23, the first partition 27 is extended to form a guide 27a for the spring 26, as shown in FIG. 5. The first partition 27 is configured in such a manner that each of the first and second compartments 20a and 20b can be emptied independently of each other. The first partition 27 need not include any openings. The first and second compartments 20a and 20b need not communicate other than via the passage 23b. The first and second compartments 20a and 20b can thus extend essentially each on a respective side of a plane containing the longitudinal axis of the passage 23b.

In the exemplary embodiment shown, one of the compartments 20a and 20b can be emptied without the other compartment emptying.

The reservoir 20 can be held on the spray mechanism 10 merely by friction due to the O-ring 24 pressing against the wall of the housing 70. Preferably, additional fastening means are provided which may comprise, for example, a link relying on complementary shape, for example, comprising a groove 74 in which a dovetail-shaped rib 75 can be engaged. The groove 74 and the rib 75 may extend along a longitudinal axis that is oriented parallel to the axis of the endpiece 23, with the groove 74 being formed in the casing 11, for example.

Naturally, the invention is not limited to the embodiments described above.

For example, the spray device 1 may have still other shapes, such as a function of the size of the pressurized receptacle 40 and the shape of the reservoir 20 containing the substance to be sprayed.

Where appropriate, the spray device 1 may be arranged to receive a plurality of reservoirs containing different substances for spraying and may include a selector suitable for putting a selected one of the reservoirs into communication with the spray mechanism so as to spray one of the substances as selected by the user. Under such circumstances, the reservoirs may contain substances, such as foundations, of different colors.

The pressurized receptacle preferably contains a vector gas in liquefied form. Nevertheless, it is contemplated by the present invention for the pressurized receptacle to contain compressed air, for example, being arranged to be capable of being periodically refilled via a small compressor.

In the exemplary embodiments described above, the spray head 30 comprises a plurality of nozzles. However, it is contemplated by the present invention for the vector gas to be issued through a single nozzle.

Throughout the description and the claims, the term “comprising a” should be understood as being synonymous with “comprising at least one,” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A spray device comprising:
a spray mechanism; and
a reservoir containing a substance for spraying, arranged in such a manner as to be capable of being removably mounted on the device so that the substance can be selectively dispensed by the spray mechanism, the reservoir comprising:
a substance outlet passage;
a closure member for closing said passage when the reservoir is not mounted on the device, the spray mechanism and the closure member being arranged in such a manner that the closure member opens in response to the reservoir being mounted on the device;
at least a first partition; and
first and second compartments capable of containing the substance, the compartments being arranged to feed the spray mechanism with the substance and being disposed on either side of said first partition, wherein the substance comprises a cosmetic or a care product.

2. A device according to claim 1, wherein the passage opens out at one end thereof on either side of the first partition.

3. A device according to claim 1, wherein the closure member comprises a ball check valve.

4. A device according to claim 3, wherein the spray mechanism comprises a portion in relief arranged, when the reservoir is mounted on the device, to move the ball from a first position closing the passage to a second position opening the passage.

5. A device according to claim 1, wherein the reservoir comprises at least one second partition on one side of the first partition, the second partition being associated with the first compartment and defining therein two sub-compartments that are in communication with each other.

6. A device according to claim 5, wherein the reservoir comprises at least one third partition associated with the second compartment and defining therein two sub-compartments, the first partition being situated between the second and third partitions.

7. A device according to claim 1, wherein the reservoir comprises a base portion and a lid-forming portion fitted on the base portion.

8 A device according to claim 6, wherein the reservoir comprises a base portion and a lid-forming portion fitted on the base portion, and wherein the second and third partitions are made integrally with at least one of the base portion and the lid-forming portion.

9. A device according to claim 1, wherein the substance outlet passage is defined at least in part by an endpiece.

10. A device according to claim 9, wherein the endpiece projects from the reservoir.

11. A device according to claim 9, wherein the endpiece carries a sealing O-ring.

12. A device according to claim 1, wherein the reservoir is at least partially transparent.

13. A device according to claim 1, wherein the reservoir comprises a fastener arranged to co-operate by complementary shapes with the spray mechanism.

14. A device according to claim 1, wherein the substance is sprayed by suction created by a stream of vector gas.

15. A device according to claim 14, wherein the vector gas is stored in liquefied form in a pressurized receptacle.

16. A device according to claim 1, wherein the spray mechanism includes a control member arranged to act simultaneously both on a vector gas dispenser valve and on a valve for adjusting the flow rate of the sprayed substance.

17. A device according to claim 1, wherein the reservoir is generally elongate in shape, having a longitudinal axis substantially parallel to a direction in which spraying takes place.

18. A device according to claim 9, wherein the first partition extends inside the endpiece.

19. A device according to claim 1, wherein the first and second compartments are not in communication other than via the substance outlet passage.

20. A spray device comprising:
a spray mechanism comprising a housing for receiving a vector gas supply; and
a reservoir containing a substance to be sprayed and arranged in such a manner as to be capable of being releasably mounted on the device so that the substance can be selectively dispensed by the spray mechanism, the reservoir comprising:
a substance outlet passage; and
a closure member to close said passage when the reservoir is not mounted on the device, the spray mechanism and the closure member being arranged in such a manner that the closure member opens in response to the reservoir being mounted on the device.

21. A spray device for spraying at least one substance contained in a reservoir, the substance being taken from the reservoir by suction created at an outlet orifice of the reservoir by a stream of vector gas, the vector gas being stored in a pressurized receptacle, said device comprising an adjustment valve for adjusting a flow rate of the sprayed substance and a control member capable of being operated by a user to act both on a vector gas dispenser valve and on the adjustment valve, the adjustment valve comprising a plunger arranged to co-operate with an associated seat so that the flow rate of the sprayed substance varies with varying spacing between the seat and the plunger, the substance comprising a cosmetic or a care product.

22. A device according to claim 21, wherein the control member comprises a pivoting lever.

23. A device according to claim 21, wherein the dispenser valve is secured to the pressurized receptacle.

24. A device according to claim 23, wherein the dispenser valve is triggered by tilting a control rod.

25. A device according to claim 21, wherein the seat is situated on a support piece for supporting at least one nozzle for spraying the substance.

26. A device according to claim 25, wherein the support piece is made of plastics material.

27. A device according to claim 26, wherein the support piece is releasably fastened on the device.

28. A device according to claim 21, wherein the substance reservoir is removable.

29. A device according to claim 21, further comprising two outlet nozzles for the vector gas and an outlet nozzle for the substance to be sprayed.

30. A device according to claim 25, wherein the at least one nozzle is made of metal.

31. A device according to claim 21, further comprising two vector gas outlet nozzles having axes that converge in a direction going away from the device.

32. A device according to claim 31, wherein the substance outlet orifice comprises an axis situated substantially in a same plane as the axes of the vector gas outlet nozzles.

33. A device according to claim 21, wherein the plunger is slidable in a direction substantially parallel to a direction along which the substance is sprayed.

34. A device according to claim 21, further comprising a housing for receiving the pressurized receptacle.

35. A device according to claim 34, further comprising a movable cap that enables access to the housing to be closed.

36. A device according to claim 21, further comprising a return spring for returning the plunger toward a rest position in which the plunger is pressed against the seat.

37. A device according to claim 21, wherein the control member does not include a return spring associated only with the control member.

38. A device according to claim 21, further comprising an endpiece arranged to be engaged on a control rod of the dispenser valve, wherein the control member is arranged to be capable of pressing against said endpiece.

39. A device according to claim 21, further comprising a hinged mirror.

40. A device according to claim 21, wherein the device is generally elongate in shape and the control member comprises a presser face placed on a longitudinal side of the device to be pressed by a user.

41. A device according to claim 21, wherein the reservoir of substance and the pressurized receptacle are held together in a fixed manner without movement relative to one another in use.

42. A device according to claim 21, wherein the reservoir includes a micro-orifice opening to the ambient atmosphere.

43. A device according to claim 1, wherein the substance comprises a cosmetic.

44. A device according to claim 1, wherein the substance comprises a care product.

45. A device according to claim 21, wherein the substance comprises a cosmetic.

46. A device according to claim 21, wherein the substance comprises a care product.
